(19) United States
(12) Patent Application Publication
(10) Pub. No.: US 2025/0252392 A1
(43) Pub. Date: Aug. 7, 2025

(54) METHODS AND APPARATUS TO FACILITATE ONE-CLICK RETURNS

(71) Applicant: Returned.com, Inc., Boulder, CO (US)

(72) Inventors: Patrick A. Justis, Longmont, CO (US); Paul Pao-Yen Lin, Boulder, CO (US)

(21) Appl. No.: 18/903,748

(22) Filed: Oct. 1, 2024

Related U.S. Application Data
(60) Provisional application No. 63/549,868, filed on Feb. 5, 2024.

(51) Int. Cl. G06Q 10/0837; G06F 3/0481; G06Q 30/0601

(52) U.S. Cl. CPC G06Q 10/0837; G06F 3/0481; G06Q 30/0633

(57) ABSTRACT

Systems, apparatus, articles of manufacture, and methods for facilitating one-click returns are disclosed. Example instructions, when executed, cause at least one processor circuit to aggregate order information from at least one retailer; provide the aggregated order information to a consumer device, the aggregated order information representing one or more products that are available for return; in response to selection of a product to be returned, identify a proposed value for return of the product based on at least one of product information, transportation information, retailer information, or consumer information; provide the proposed value to the consumer device, the proposed value to be used as a default value for a return field, a selected value of the return field to be used in coordination of return of the product; and access a return instruction from the consumer device, the return instruction identifying the product to be returned and the selected value; and after access of the return instruction, communicate with a retailer associated with the product to coordinate return of the product based on the selected value.

### RELATED APPLICATION

This patent claims the benefit of U.S. Provisional Patent Application No. 63/549,868, which was filed on Feb. 5, 2024. U.S. Provisional Patent Application No. 63/549,868 is hereby incorporated herein by reference in its entirety. Priority to U.S. Provisional Patent Application No. 63/549,868 is hereby claimed.

### FIELD OF THE DISCLOSURE

This disclosure relates generally to consumer advocacy and, more particularly, to methods and apparatus to facilitate one-click returns.

### BACKGROUND

In recent years, increases in commercialism and digital advertising have led to a rise in consumer purchasing. In many examples, a consumer may purchase a product, only to later return the product. A consumer may return a product for any reason, including but not limited to, the product arriving as damaged, the product not matching a corresponding description, the consumer finding an alternative product with lower cost and/or better performance, and/or more generally, the consumer no longer wanting or needing the originally purchased product.

### BRIEF DESCRIPTION OF THE DRAWINGS

FIG. 1 is a block diagram of an example environment in which example return circuitry interacts with a return coordinator server to initiate coordination of return of an item.

FIG. 2 is a block diagram of an example implementation of the example return coordinator server of FIG. 1.

FIG. 3 is a block diagram of an example implementation of the example return circuitry of FIG. 1.

FIG. 4 is a flowchart representative of example machine readable instructions and/or example operations that may be executed, instantiated, and/or performed by example programmable circuitry to implement the return coordinator server of FIG. 1 to aggregate purchase information.

FIG. 5 is a flowchart representative of example machine readable instructions and/or example operations that may be executed, instantiated, and/or performed by example programmable circuitry to implement the return circuitry of FIG. 1 to enable initiation of a return.

FIG. 6 is a flowchart representative of example machine readable instructions and/or example operations that may be executed, instantiated, and/or performed by example programmable circuitry to implement the return coordinator server of FIG. 1 to provide proposed return settings to the return circuitry.

FIG. 7 is a flowchart representative of example machine readable instructions and/or example operations that may be executed, instantiated, and/or performed by example programmable circuitry to implement the return coordinator server of FIG. 1 to interact with a retailer to coordinate return of an item.

FIG. 8 is an example user interface that may be displayed at the direction of the return circuitry of FIG. 1 to display items that may be returned.

FIG. 9 is an example user interface that may be displayed at the direction of the return circuitry of FIG. 1 to display proposed settings for return of an item.

FIG. 10 is a block diagram of an example processing platform including programmable circuitry structured to execute, instantiate, and/or perform the example machine readable instructions and/or perform the example operations of FIGS. 4, 6, and/or 7 to implement the return coordinator server 110 of FIG. 2.

FIG. 11 is a block diagram of an example processing platform including programmable circuitry structured to execute, instantiate, and/or perform the example machine readable instructions and/or perform the example operations of FIG. 5 to implement the return circuitry of FIG. 3.

FIG. 12 is a block diagram of an example implementation of the programmable circuitry of FIGS. 10 and/or 11.

FIG. 13 is a block diagram of another example implementation of the programmable circuitry of FIGS. 10 and/or 11.

FIG. 14 is a block diagram of an example software/firmware/instructions distribution platform (e.g., one or more servers) to distribute software, instructions, and/or firmware (e.g., corresponding to the example machine readable instructions of FIGS. 4, 5, 6, and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Consumers can purchase goods and/or services through many different retailers and/or entities. Such consumers may, in some examples, seek to return and/or cancel such goods and/or services. Different retailers and/or entities may utilize different platforms that enable a consumer to request a refund and/or return of a purchased good or service.

Consumers routinely interact with entities to purchase goods, services, etc. Some entities implement policies by which a consumer may interact with the entity. Such interactions may support various actions conducted between the consumer and the entity such as, for example, returning a purchased item, negotiating a new price for a service, etc. Some entities may invest in infrastructure that enables such interactions to be conducted in an efficient manner for a consumer. For example, some retailers enable a consumer to fill out a return form on their website by clicking a link and requesting the return of an item. However, not all entities are as user-friendly. Some entities might implement text-based (e.g., a chat session, an email address) and/or voice-based (e.g., a telephonic voice session) customer service department(s) with which the consumer may interact. In such instances, interacting with such text-based and/or telephone-based customer service agents might overly be time-consuming for consumers. Moreover, because different entities might use different customer service systems, consumers are faced with understanding the various systems for interacting with the different entities.

Consumers desire, and would benefit from, a unified platform by which they may return items to various retailers and/or entities. U.S. Provisional Patent Application No. 63/495,963 describes approaches for interacting with such retailers and/or entities on behalf of the consumer. U.S. Provisional Patent Application No. 63/495,963 is hereby incorporated by reference in its entirety.

Examples disclosed herein enable aggregation of consumer purchases across multiple retailers, and display of the user interface that enables a consumer to trigger an interaction with a retailer on behalf of the consumer to, for example, return a purchased item. Advantageously, parameters to be used when interacting with the entity on behalf of the consumer may be pre-populated with suggested values based on, for example, consumer preferences, consumer history, trends when interacting with a given entity, etc. such parameters may include, for example, whether the item to be returned is to be picked up from a consumer location, dropped off by a consumer, a reason for returning the item, the desired refund method, etc. Examples disclosed herein enable presentation of proposed settings to be used when interacting with the retailer to return an item. Such proposed settings are presented to a user in an easy-to-use manner such that, in many circumstances, the user may be able to trigger the initiation of a return without having to modify parameters to be used during the return.

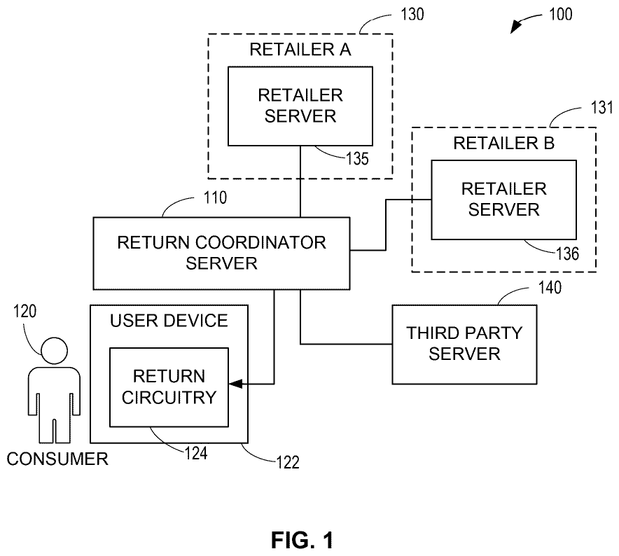

FIG. 1 is a block diagram of an example environment 100 in which example return circuitry 124 interacts with a return coordinator server 110 to initiate an interaction with a retailer 130, 131. In the illustrated example of FIG. 1 the return coordinator server 110 interacts with one or more third-party servers 140 to identify purchased information of a consumer 120 from one or more retailers 130, 131. In some examples, the return coordinator server 110 may interact with a retailer server 135, 136 to obtain the purchase information of the consumer 120. Such purchase information may identify items that were purchased, services that are subscribed to by the consumer 120, date(s) of purchase, purchase prices, and/or any other details concerning past purchases of the consumer 120, etc.

The example third-party server 140 of the illustrated example of FIG. 1 may be implemented using an email server and/or service at which the consumer 120 may receive order confirmations (e.g., emails). In examples disclosed herein, the consumer 120 may provide authorization and/or login information to the return coordinator server 110 to enable the return coordinator server 110 to communicate with the third-party server 140 to collect such purchase information.

Upon collection and aggregation of the purchase information, the example return coordinator server 110 communicates the purchase information to the return circuitry 124 of the user device 122. In the illustrated example of FIG. 1, the user device 122 represents a smart phone and/or tablet of the consumer. However, any other type of user device 122 may additionally or alternatively be used including, for example, laptop computers, desktop computers, smart watches, televisions, etc.

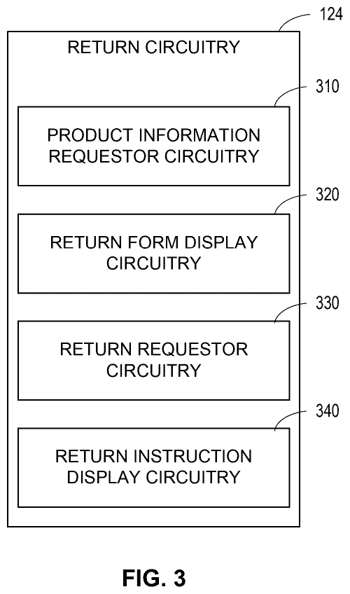

The example return circuitry 124 of the illustrated example of FIG. 1 may be implemented using an application that is executed by the user device 122. Additionally or alternatively, the example return circuitry 124 may be implemented in any other manner including, for example, within a browser of the example user device 122. An example implementation of the return circuitry 124 is described in further detail below in connection with FIG. 3.

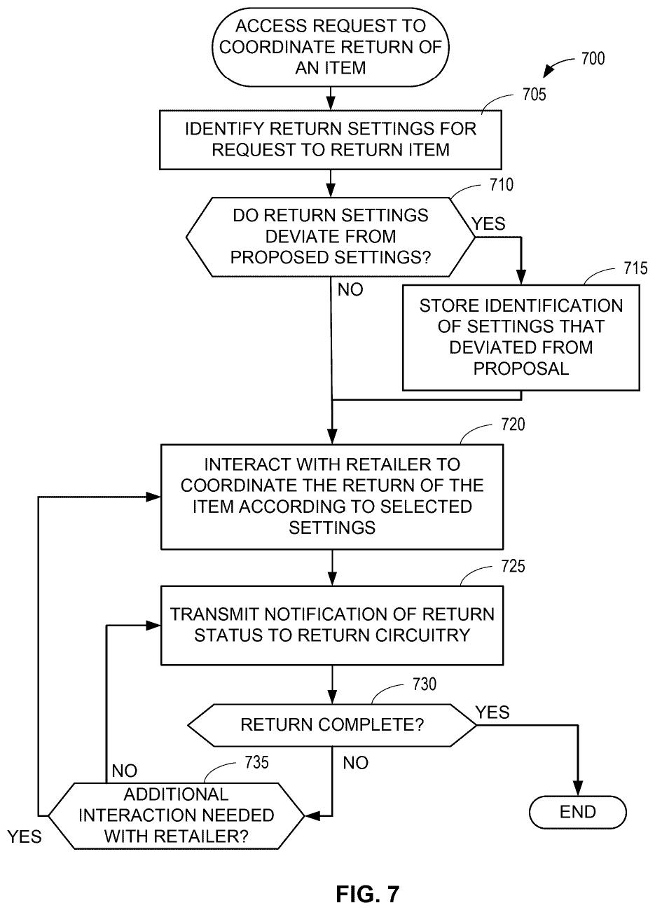

The example return circuitry 124 the illustrated example of FIG. 1 enables presentation of a first user interface that lists goods that may be returned. An example representation of the first interface is described below in connection with FIG. 7. Whether or not a purchased good is displayed by the return circuitry 124 may be dependent upon one or more factors including, for example, a type of the product, policies of the retailer from which the good was purchased, the date of purchase, date of delivery, information concerning a history of the retailer accepting returns outside of their predefined return windows, etc. From the first user interface, the consumer 120 may select an item to be returned. In response to the selection, the example return circuitry 124 may communicate with the return coordinator server 110 to request proposed settings (e.g., proposed setting values, proposed values) to be used during the return of the item.

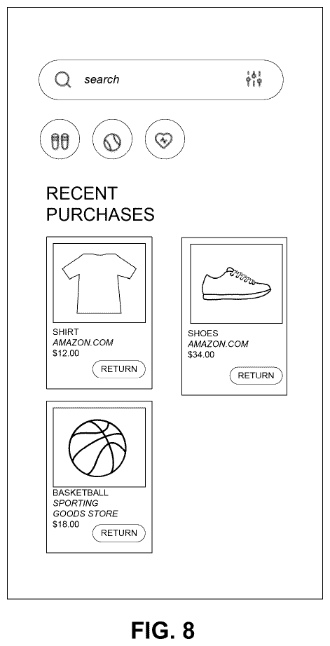

The example return coordinator server 110 determines such proposed settings and sends the proposed settings to the return circuitry 124 for display to the consumer 120 in a second user interface. Such proposed settings, and/or modifications thereto, may then be used by the return coordinator server 110 when interacting with the entity to return the item. An example of the second interface is described below in connection with FIG. 8. Advantageously, the proposed settings may be learned over time based on user history, types of items, user preferences, knowledge of return procedures and/or trends with the entity, etc. As a result, many users may not need to adjust the proposed settings, resulting in an interaction where the user may simply click (e.g., press) one button to initiate return of the item. At the direction of the consumer 120 (e.g., in response to a user clicking an “initiate return” button), the return circuitry 124 may then instruct the return coordinator server 110 to interact with the retailer from which the item was purchased to return the item. The example return coordinator server 110 conducts such interaction with the corresponding retailer in accordance with the return parameters provided by the consumer.

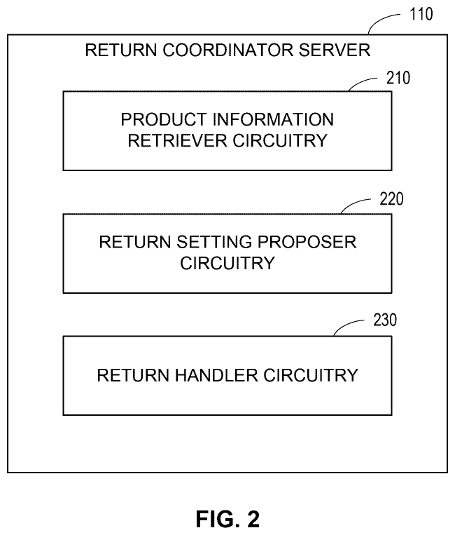

FIG. 2 is a block diagram of an example implementation of the return coordinator server 110 of FIG. 1. The return coordinator server 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the return coordinator server 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

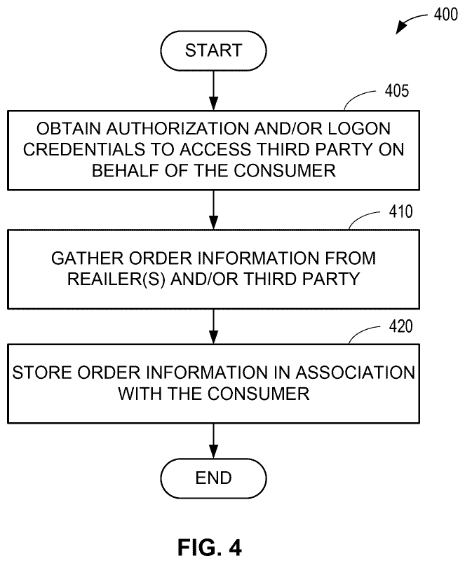

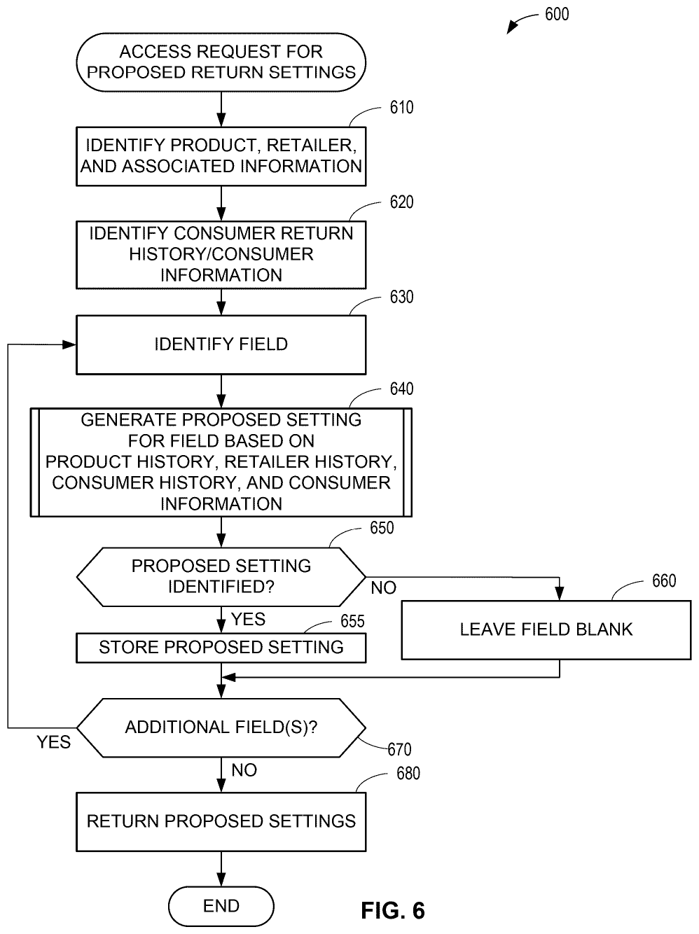

The example return coordinator server 110 the illustrated example of FIG. 2 includes product information retriever circuitry 210, return setting proposer circuitry 220, and return handler circuitry 230. In some examples, the return coordinator server 110 is instantiated by programmable circuitry executing return coordination instructions and/or configured to perform operations such as those represented by the flowchart(s) of FIGS. 4, 6, and/or 7.

The example product information retriever circuitry 210 of the illustrated example of FIG. 2 obtains authorization and/or login credentials to access the third-party server 140 and/or the retailer server 135, 136 on behalf of the consumer 120. Authorization may be obtained using an open authorization (OAUTH) mechanism to allow the consumer 120 to grant the return coordinator server 110 access to the third-party server 140 and/or the retailer server 135, 136. Using such authorization and/or credentials, the example product information retriever circuitry 210 gathers order information from the retailer server 135, 136 and/or the third-party server 140. In some examples, the example product information retriever circuitry 210 may obtain product information from scanning of receipts (e.g., as provided by a consumer), direct application programming interface (API) integration with a retailer, etc.

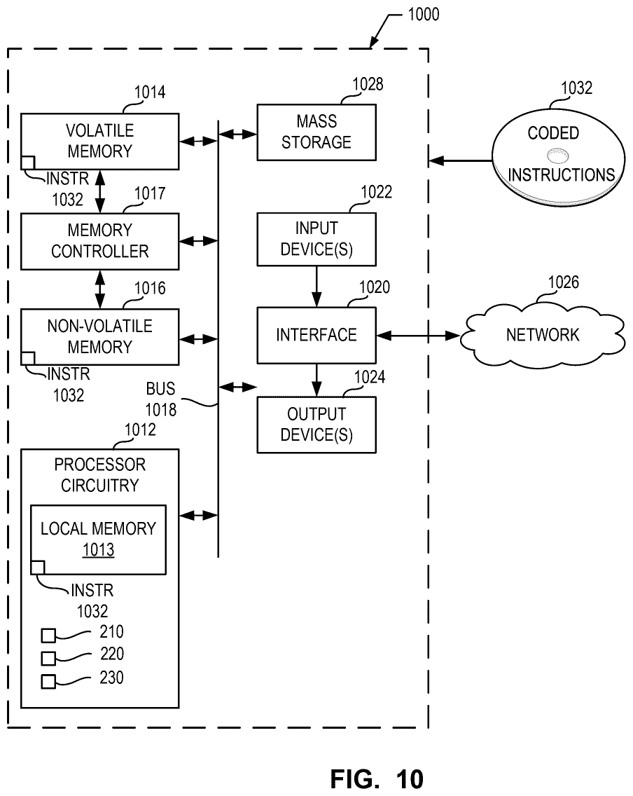

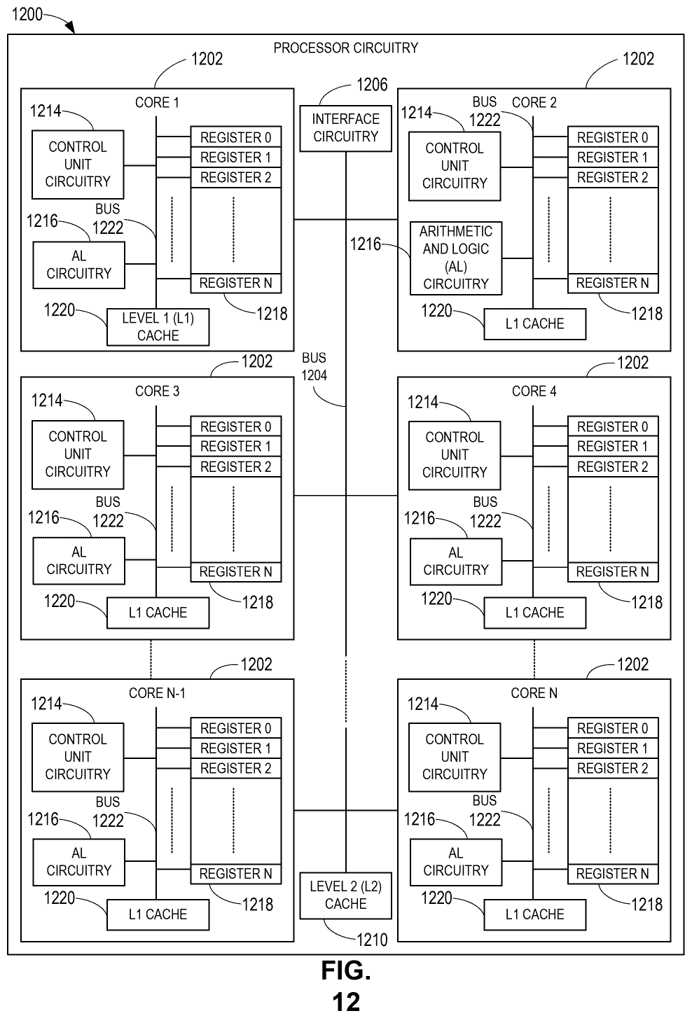

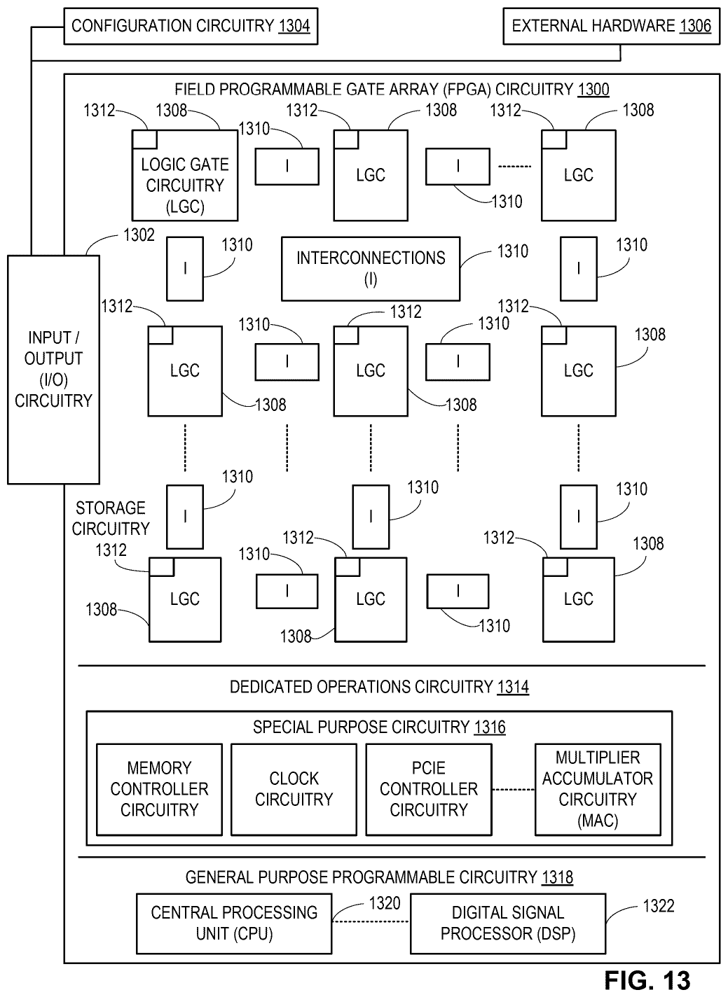

In some examples, the return coordinator server 110 includes means for retrieving order information. For example, the means for retrieving may be implemented by product information retriever circuitry 210. In some examples, the product information retriever circuitry 210 may be instantiated by programmable circuitry such as the example programmable circuitry 1012 of FIG. 10. For instance, the product information retriever circuitry 210 may be instantiated by the example microprocessor 1200 of FIG. 12 executing machine executable instructions such as those implemented by at least blocks 410, 420 of FIG. 4. In some examples, the product information retriever circuitry 210 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the product information retriever circuitry 210 may be instantiated by any other combination of hardware, software, and/or firmware. For example, the product information retriever circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example return setting proposer circuitry 220 of the illustrated example of FIG. 2 generates proposed return settings for use in coordination of return of an item. In some examples, the proposed return setting is generated using machine learning techniques including, for example, a neural network, a large language model, etc.

A large language model (LLM) operates by utilizing a neural network architecture known as a Transformer. LLMs are designed to understand and generate human-like text based on the vast amount of data on which the LLM has been trained. In the illustrated example of FIG. 2, the return setting proposer circuitry 220 may execute and/or cause execution of an LLM. Such an LLM may be executed and/or implemented locally at the return coordinator server 110 or at a computing system remote from the return coordinator server 110. For example, large language models may be executed in a cloud setting (e.g., remotely from the return coordinator server 110). Remote execution offers some advantages including, for example, that the LLM can be accessed from anywhere, providing scalability and ease of use. Cloud-based models are usually more powerful than locally executed models, as cloud-based models typically leverage high-performance hardware and are continuously updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity with more control over their data, and potentially lower latency for inference. Local execution can also work offline, which is beneficial in scenarios with limited Internet access or where data privacy is important. However, local execution typically requires powerful hardware, significant storage, and regular updates to maintain model performance.

In examples disclosed herein, the example return setting proposer circuitry 220 may execute and/or implement the LLM by generating a prompt that is provided to the LLM, and reviewing an output of the execution of the LLM. Additionally or alternatively, the return setting proposer circuitry 220 may be implemented using other techniques besides the use of an LLM to generate proposed return settings. For example, programmed logic may be used in certain situations (e.g., to select a drop-off location having the closest proximity to the consumer), a neural network may be used to generate a proposal for a particular field, etc. Moreover, because different fields may have proposed settings generated by the return setting proposer circuitry 220, different techniques may be utilized to generate each different field. For example, a neural network approach may be used to propose whether the consumer will drop off the product at a location or have it picked up at a location of the consumer, whereas a large language model may be used to generate a proposed reason for the return.

In some examples, the return coordinator server 110 includes means for proposing a return setting. For example, the means for proposing may be implemented by return setting proposer circuitry 220. In some examples, the return setting proposer circuitry 220 may be instantiated by programmable circuitry such as the example programmable circuitry 1012 of FIG. 10. For instance, the return setting proposer circuitry 220 may be instantiated by the example microprocessor 1200 of FIG. 12 executing machine executable instructions such as those implemented by at least blocks 610, 620, 630, 640, 650, 655, 660, 670, and/or 680 of FIG. 6 and/or blocks 710 and/or 715 of FIG. 7. In some examples, return setting proposer circuitry 220 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the return setting proposer circuitry 220 may be instantiated by any other combination of hardware, software, and/or firmware. For example, the return setting proposer circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example return handler circuitry 230 the illustrated example of FIG. 2 interacts with a retailer to coordinate the return of an item according to return settings provided at the direction of the consumer. To do so, the example return handler circuitry 230 utilizes one or more machine learning models, LLMs, etc. to prepare messages to be used to interact with the retailer on behalf of the consumer. Such interaction may be conducted with the retailer via, for example, a web-based user interface, a chat bot, email messages, text messages, audio messages, etc. The example return handler circuitry 230 interacts with the retailer on behalf of the consumer to coordinate return of an item, and subsequently provides instructions to the consumer concerning completion of the return. For example, such instructions may indicate to the consumer that they are to place an item on their doorstep and that a courier service has been scheduled to retrieve the item.

In some examples, the return coordinator server 110 includes means for handling coordination of a return. For example, the means for handling may be implemented by return handler circuitry 230. In some examples, the return handler circuitry 230 may be instantiated by programmable circuitry such as the example programmable circuitry 1012 of FIG. 10. For instance, the return handler circuitry 230 may be instantiated by the example microprocessor 1200 of FIG. 12 executing machine executable instructions such as those implemented by at least blocks 720, 725, 730, 735 of FIG. 7. In some examples, the return handler circuitry 230 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the return handler circuitry 230 may be instantiated by any other combination of hardware, software, and/or firmware. For example, the return handler circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example implementation of the return circuitry 124 of FIG. 1. The return circuitry 124 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the return circuitry 124 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

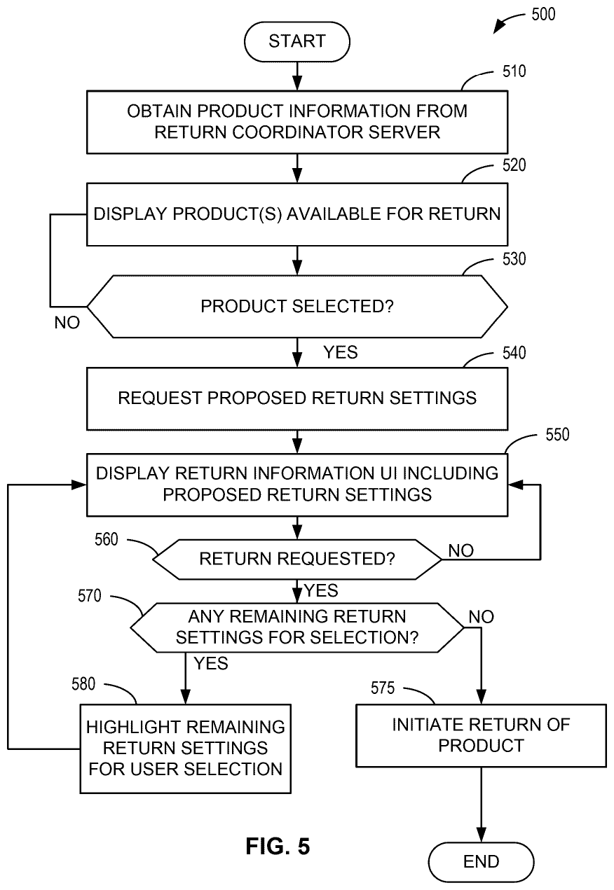

The example return circuitry 124 of the illustrated example of FIG. 3 includes product information requester circuitry 310, return form display circuitry 320, return requester circuitry 330, and return instruction display circuitry 340. In some examples, the return circuitry 124 is instantiated by programmable circuitry executing return instructions and/or configured to perform operations such as those represented by the flowchart of FIG. 5.

The example product information requester circuitry 310 the illustrated example of FIG. 3 obtains product information from the return coordinator server 110. The product information includes, for example, products associated with orders identified by the return coordinator server 110, a type of a product, a size of a product, a weight of a product, a date of purchase, a date of delivery, transportation constraints associated with a product, and return policies associated with a product. In examples disclosed herein, the product information is formatted using JavaScript object notation (JSON). However, any other data format may additionally or alternatively be used to identify products to the example product information requestor circuitry 310.

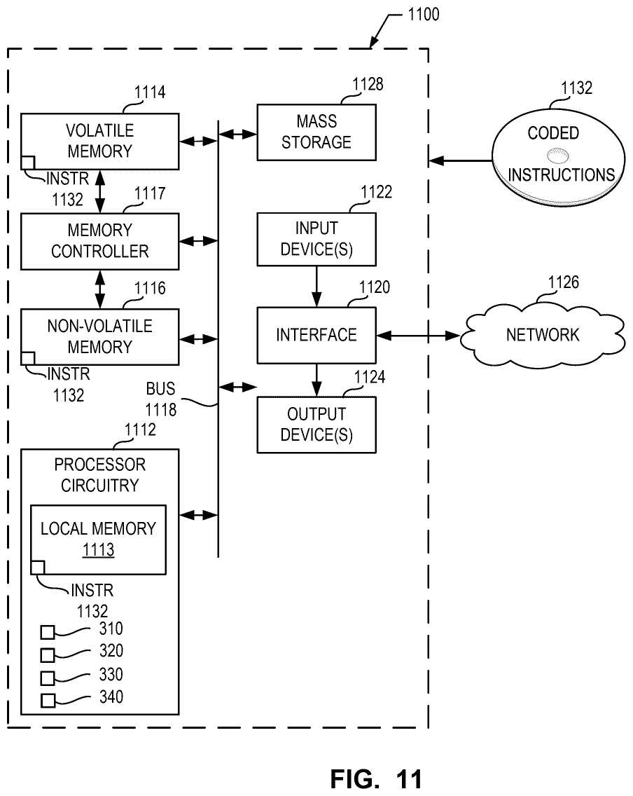

In some examples, the return circuitry 124 includes means for obtaining product information. For example, the means for obtaining may be implemented by product information requestor circuitry 310. In some examples, the product information requestor circuitry 310 may be instantiated by programmable circuitry such as the example programmable circuitry 1112 of FIG. 11. For instance, the product information requestor circuitry 310 may be instantiated by the example microprocessor 1200 of FIG. 12 executing machine executable instructions such as those implemented by at least block 510 of FIG. 5. In some examples, the product information requestor circuitry 310 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the product information requestor circuitry 310 may be instantiated by any other combination of hardware, software, and/or firmware. For example, the product information requestor circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example return form display circuitry 320 the illustrated example of FIG. 3 causes display of a first user interface that identifies products that are available for return. Such a first user interface is disclosed below in connection with FIG. 7. In some examples, the return form display circuitry 320 causes display of a second user interface that identifies return settings to be used when coordinating return of a product. In some examples, when a consumer indicates their intent to have return of a product coordinated, the example return form display circuitry 320 may review the selected values of various return settings to confirm that any settings that are critical for coordination of the return are provided.

In some examples, the return circuitry 124 includes means for causing display of a return form. For example, the means for causing may be implemented by return form display circuitry 320. In some examples, the return form display circuitry 320 may be instantiated by programmable circuitry such as the example programmable circuitry 1112 of FIG. 11. For instance, the return form display circuitry 320 may be instantiated by the example microprocessor 1200 of FIG. 12 executing machine executable instructions such as those implemented by at least blocks 520, 560 of FIG. 5. In some examples, the return form display circuitry 320 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the return form display circuitry 320 may be instantiated by any other combination of hardware, software, and/or firmware. For example, the return form display circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example return requester circuitry 330 the illustrated example of FIG. 3 causes transmission of a request for coordination of return of a product to the return coordination server 110. When requesting coordination of the return of the product, the example return requestor circuitry 330 provides the selected return settings to the return coordinator server 110. In some examples, the example return requester circuitry 330 may provide only those fields that deviated from the proposed return settings. In such examples, additional metadata including, for example, a reason for why the consumer 120 deviated from the proposed return setting may be included. Having stored the proposed settings, the return coordinator server 110 may recall the remaining proposed settings that the consumer did not modify, as those un-modified fields might not be included in the request to coordinate return of the product.

In examples disclosed herein, the request for coordination of the return of the product is transmitted using a hypertext transfer protocol secure (HTTPS) message. However, any other messaging format and/or technology may additionally or alternatively be used such as, for example, hypertext transfer protocol (HTTP), Simple Object Access Protocol (SOAP), web sockets, etc. Such a message includes a payload that identifies the requested return settings. In some examples, the payload is formatted using a JavaScript Object Notation (JSON). However, any other payload format may additionally or alternatively be used.

In some examples, the return circuitry 124 includes means for requesting coordination of a return. For example, the means for requesting may be implemented by return requester circuitry 330. In some examples, the return requester circuitry 330 may be instantiated by programmable circuitry such as the example programmable circuitry 1112 of FIG. 11. For instance, the return requester circuitry 330 may be instantiated by the example microprocessor 1200 of FIG. 12 executing machine executable instructions such as those implemented by at least blocks 540, 575, of FIG. 5. In some examples, the return requester circuitry 330 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the return requester circuitry 330 may be instantiated by any other combination of hardware, software, and/or firmware. For example, the return requester circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example return instruction display circuitry 340 the illustrated example of FIG. 3 causes the user device 122 to present instructions to the consumer to enable completion of the return. In some examples, a status of a return being coordinated may additionally or alternatively be displayed.

In some examples, the return circuitry 124 includes means for presenting instructions to a consumer. For example, the means for presenting may be implemented by return instruction display circuitry 340. In some examples, the v may be instantiated by programmable circuitry such as the example programmable circuitry 1112 of FIG. 11. For instance, the return instruction display circuitry 340 may be instantiated by the example microprocessor 1200 of FIG. 12 executing machine executable instructions. In some examples, the v may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the return instruction display circuitry 340 may be instantiated by any other combination of hardware, software, and/or firmware. For example, the return instruction display circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the return coordinator server 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example product information retriever circuitry 210, the example return setting proposer circuitry 220, the example return handler circuitry 230, and/or, more generally, the example return coordinator server 110 of FIG. 2, may be implemented by hardware alone or by hardware in combination with software and/or firmware. Thus, for example, any of the example product information retriever circuitry 210, the example return setting proposer circuitry 220, the example return handler circuitry 230, and/or, more generally, the example return coordinator server 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example return coordinator server 110 of FIG. 2 may include one or more elements, processes, and/or devices in addition to, or instead of, those illustrated in FIG. 2, and/or may include more than one of any or all of the illustrated elements, processes and devices.

Additionally, while an example manner of implementing the return circuitry 124 of FIG. 1 is illustrated in FIG. 3, one or more of the elements, processes, and/or devices illustrated in FIG. 3 may be combined, divided, re-arranged, omitted, eliminated, and/or implemented in any other way. Further, the example product information requestor circuitry 310, the example return form display circuitry 330, the example return instruction display circuitry 340, and/or, more generally, the example return circuitry 124 of FIG. 3, may be implemented by hardware alone or by hardware in combination with software and/or firmware. Thus, for example, any of the example product information requestor circuitry 310, the example return form display circuitry 330, the example return instruction display circuitry 340, and/or, more generally, the example return circuitry 124, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example return circuitry 124 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the return coordinator server 110 of FIG. 2 and/or representative of example operations which may be performed by programmable circuitry to implement and/or instantiate the return coordinator server 110 of FIG. 2, are shown in FIGS. 4, 6, and/or 7. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

A flowchart representative of example machine readable instructions, which may be executed by programmable circuitry to implement and/or instantiate the return circuitry 124 of FIG. 3 and/or representative of example operations which may be performed by programmable circuitry to implement and/or instantiate the return circuitry 124 of FIG. 3, is shown in FIG. 5. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, 6, and/or 7, many other methods of implementing the example return coordinator server 110 may alternatively be used. Likewise, although the example program is described with reference to the flowchart illustrated in FIG. 5, many other methods of implementing the example return circuitry 124 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4, 5, 6, and/or 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by example programmable circuitry to implement the return coordinator server 110 of FIG. 1 to aggregate purchase information. The example process 400 of the illustrated example of FIG. 4 begins when the example product information retriever circuitry 210 obtains authorization and/or login credentials to access the third-party server 140 on behalf of the consumer 120. (Block 405). For example, open authorization (OAUTH) may be used to enable the consumer 120 to grant the return coordinator server 110 permission to access the third-party server 140 on behalf of the consumer 120. Additionally or alternatively, the consumer 120 may provide login information and their credentials to the return coordinator server 110 to enable the return coordinator server 110 to communicate with the third-party server 140 on behalf of the consumer. Advantageously, using an OAUTH approach ensures that the consumer does not need to inform the return coordinator server 110 of changes in their credentials (e.g., an updated password). Additionally or alternatively, the example return coordinator server 110 may access a retailer server 135, 136 on behalf of the consumer 120 (e.g., using OAUTH, using user credentials, etc.) to identify purchases made at the corresponding retailer by the consumer. Any other approach to allowing the consumer to delegate authority for the return coordinator server to access the retailer server 135, 136 and/or the third-party server 140 may additionally or alternatively be used.

Once access to the retailer server 135 and/or the third-party server 140 is established, the example product information retriever circuitry 210 gathers order information from the retailer server 135, 136 and/or the third-party server 140. (Block 410). When retrieved from the third-party server 140, the order information may include information about products purchased from multiple different retailers. Conversely, order information obtained from a retailer server might include order information specific only to the retailer operating the corresponding retailer server (or perhaps a collection of related retailers). In such examples, the consumer might need to provide authorization and/or credentials to the return coordinator server 110 corresponding to multiple different retailers from which the consumer may have purchased goods. Advantageously, having the consumer 120 to provide authorization for the return coordinator server 110 to access order information from the third-party server 140 (e.g., an email server) is typically more efficient than individual retailers, as the consumer is likely to have order information from multiple different retailers present at the third-party server.

Having access the order information from the retailers and/or third-party server, the example product information retriever circuitry stores the collected order information in association with the consumer 120. (Block 420). In examples disclosed herein, the order information is stored in a memory of the return coordinator server 110 (e.g., a database). However, the order information may be stored in any other location. The example process 400 of FIG. 4 then terminates. The example process 400 of FIG. 4 and/or a portion thereof may then be repeated at a later time to enable subsequent collection of future order information.

FIG. 5 is a flowchart representative of example machine readable instructions and/or example operations that may be executed, instantiated, and/or performed by example programmable circuitry to implement the return circuitry 124 of FIG. 1 to enable initiation of a return. The example process 500 of the illustrated example of FIG. 5 begins when the example product information requestor circuitry 310 obtains product information from the return coordinator server 110. (Block 510). The product information includes, for example, identifications of products associated with orders identified by the return coordinator server 110. In some examples, the products included in the product information provided to the product information requestor circuitry 310 are limited to only items that are still eligible for return. For example, an item purchased 45 days ago from a retailer that has a 14 day return policy might no longer be included in a listing of items eligible for return as provided by the return coordinator server 110. However, in some examples, the product information may include items that are no longer eligible for return. Within a user interface of the return circuitry 124, the user may be provided with the ability to filter and/or sort to identify products that are eligible for return. Additionally or alternatively, other non-product items, such as subscriptions, may also be identified in the product information.

The example return form display circuitry 320 displays the products that are available for return. (Block 520). An example user interface to display products available for return is described below in connection with FIG. 7. The example return form display circuitry 320 determines whether a product has been selected by the consumer for return. (Block 530). If no product has been selected for return, the process returns to block 520 where the example return form display circuitry 320 continues to display products available for return and await user selection of a product to be returned. Upon selection of a product to be returned (e.g., block 530 returning a result of YES), the example return request or circuitry 330 requests proposed return settings from the return coordinator server 110. (Block 540). An example process by which the return coordinator server 110 replies to the request for the proposed return settings is described below in connection with FIG. 6.

While in the illustrated example of FIG. 5 the consumer selects a single item for coordination of a return, in some examples, multiple products may be selected for coordination of a return. In some examples, those multiple products may be associated with a same initial order and/or retailer. In some other examples, the multiple products may have originated from different retailers. In such an example, the coordination of the return of each of those items may be handled in parallel.

Upon selection of a product to be returned, the example return form display circuitry 320 then causes presentation of a second user interface that displays information including the proposed return settings. (Block 550). An example user interface illustrating the proposed return settings is described below in connection with FIG. 8. The example return form display circuitry 320 accepts user input to enable the consumer 120 to modify the proposed return settings to be used for return of the item. While the consumer 120 should not normally need to modify the proposed return settings, there might be instances in which a proposed return setting does not match the desire of the consumer. Upon receipt of an instruction from the consumer 120 to modify the proposed return setting, the example return form display circuitry 320 may collect additional information from the consumer 120 including, for example, whether the change to the proposed return setting is a temporary change, a reason for the change of the proposed return setting, etc. Such additional information enables the return coordinator server 110 to adjust future proposed return settings, not only for the consumer requesting the change, but perhaps for other consumers as well.

The example return form display circuitry 320 determines whether the consumer has indicated that the return is being requested. (Block 560). As shown in the example user interface below in connection with FIG. 8, an “initiate return” button may be pressed by the consumer 120 indicating their request to proceed with coordination of the return according to the selected settings. If no return is being requested (e.g., block 560 returns a result of NO), the example return form display circuitry 320 continues to display the return information user interface. (Block 550).

If the example return form display circuitry 320 determines that the consumer 120 has requested initiation of the return (e.g., block 560 returns a result of YES), the example return form display circuitry 320 determines whether there are any remaining return settings for selection. (Block 570). While ideally it is not the case, there may be situations in which the return coordinator server 110 might not be able to provide a proposed return setting for a given field. Such a situation is described below in connection with blocks 650 and 660. If, in such a situation, the consumer has not provided a selection for a particular field, (e.g., block 570 returns a result of YES), the example return form display circuitry 320 may highlight remaining return settings for user selection. (Block 580). In some examples, particular fields might not be required and, therefore, might not be highlighted or result in block 570 returning a result of YES. If a field is identified that requires further user input, the user may then input their desired value for that field. As an example, if the consumer was requesting coordination of the return of a product, and there were no return drop-off locations within a threshold distance of the current location of the consumer and/or the user device 122 (e.g., no return locations within five miles of the current location), the example return coordinator server 110 might not provide a proposed return setting for the drop-off location field. Not providing a proposed return setting of a drop-off location that is far away from the consumer 120 ensures that the consumer will be involved in selection of an appropriate drop-off location, thereby reducing potential surprise of the consumer once the return coordination is complete (e.g., when the consumer is instructed to drop off the product at the drop-off location).

In response to the return form display circuitry 320 determining that coordination of the return has been requested (e.g., block 560 returning a result of YES), and no additional remaining return settings being needed (e.g., block 570 return results of NO), the example return request or circuitry 330 communicates with the return coordinator server 110 to initiate coordination of return of the product. (Block 575). When requesting coordination of the return of the product, the example return requestor circuitry 330 provides the selected return settings to the return coordinator server 110. In some examples, the example return requester circuitry 330 may provide only those fields that deviated from the proposed return settings. In such examples, additional metadata including, for example, a reason for why the consumer 120 deviated from the proposed return setting may be included. Having stored the proposed settings, the return coordinator server 110 may recall the remaining proposed settings that the consumer did not modify, as those un-modified fields might not be included in the request to coordinate return of the product.

FIG. 6 is a flowchart representative of example machine readable instructions and/or example operations that may be executed, instantiated, and/or performed by example programmable circuitry to implement the return coordinator server 110 of FIG. 1 to provide proposed return settings to the return circuitry 124. The example process 600 of the illustrated example of FIG. 6 begins when the example return setting proposer circuitry 220 receives a request for proposed return settings. The request includes information that enables the return setting proposer circuitry 220 to identify the item to be returned, the retailer, the consumer, etc. Using the information in the request, the example return setting proposer circuitry 220 identifies the product information, the retailer information, and/or other associated information to be used in generation of the proposed return settings. (Block 610). The retailer information may include, for example, retailer drop-off location preferences, retailer shipping service provider preferences, past retailer return preferences, retailer return policies, retailer timing preferences, an address of the retailer, etc. The example return setting proposer circuitry 220 then identifies consumer return history and/or consumer information to be used in generation of the proposed return settings. (Block 620). Such consumer information may include, for example, drop-off location preferences, pick-up timing preferences, refund preferences, a current location of the consumer (e.g., based on global positioning system (GPS) coordinates included in the request message), a typical location of the consumer (e.g., historical address(es) of the consumer, a home address for the consumer, etc.), past consumer return preferences, consumer timing preferences, etc. The example return setting proposer circuitry 220 also identifies transportation information to be used in generation of the proposed return settings. Such transportation information may include, for example, temporal carrier availability (e.g., what days of the week a carrier is available to pick up a package, how long it would take a carrier to retrieve a package, etc.) and spatial carrier availability (the regions a carrier services), a carrier location (e.g., address of a store), carrier costs, packaging requirements, drop-off availability, pickup availability, route optimization, etc.

The example return setting proposer circuitry 220 identifies a field that is to have a proposed setting generated. (Block 630). The field may represent any value that might be used when coordinating return of a product with a retailer. For example, the field may identify whether the consumer will drop off the item or have the item picked up, a drop-off or pick-up location, a reason for the return, the desired refund method, information related to an exchange of the item, etc.

Using the identified product information, retailer information, transportation information, and/or consumer information, the example return setting proposer circuitry 220 generates a proposed setting (e.g., a proposed value) for the identified field. (Block 640). In examples disclosed herein, the example return setting proposer circuitry 220 employs techniques such as machine learning, artificial intelligence, and/or large language models to generate the proposed setting(s). Advantageously, such approaches can be trained and/or adapt over time to account for changing consumer preferences, new return policies, additional fields to be used, newly available pick-up services, availability for recycling, resale, and/or other services that may be provided, etc. By generating the proposed settings, the example return setting proposer circuitry 220 improves efficiency of the consumer in identifying their desire for how the return of an item is to be coordinated. This reduces manual effort on the part of the consumer, and ensures that returns are processed efficiently and effectively. By analyzing past interactions with retailers and consumers, as well as considering other relevant factors, the example return setting proposer circuitry 220 can propose a tailored setting for each field a form that is to be displayed to the consumer.

The proposed settings are adaptable based on real-time data inputs, allowing the return setting proposer circuitry 220 circuitry to continuously learn from past interactions with retailers and/or consumers, and improve the proposed settings over time. This ensures that users receive accurate and up-to-date recommendations of settings when instructing the return coordinator server 110 to coordinate a return with a retailer. Furthermore, by incorporating large language models into the system, the example return setting proposer circuitry 220 can better understand contextual information and generate more precise proposals for various fields.

In some examples, the return setting proposer circuitry 220 identifies a potential value for a proposed setting and generates a confidence score that accompanies the potential value. If the confidence score does not meet or exceed a confidence threshold, the example return setting proposer circuitry 220 might not provide the potential value as a proposed setting to the return circuitry 124. The confidence score represents a predicted likelihood a consumer associated with the consumer device will agree to the potential value. For example, if the location of the consumer suggests that there are no known drop-off locations within 3 miles from the current location of the consumer, the example return setting proposer circuitry 220 might determine that there is a low confidence in the recommendation of a drop-off location. Because the confidence does not meet the confidence threshold (e.g., block 650 returns a result of NO), the example return setting proposer circuitry 220 might leave the field blank (e.g., provide an empty value, not provide a proposed setting for a given field). (Block 660). Returning to block 650, if the example return setting proposer circuitry 220 determines that the confidence of the potential value meets the confidence threshold (e.g., block 650 returns a result of YES), the example return setting proposer circuitry 220 stores the potential value in a memory of the return coordinator server 110 for use as a proposed setting. (Block 655). In some examples, the proposed setting may be stored in a database of the return coordinator server 110 in association with an identifier of the product to be returned. Storing such information enables the return setting proposer circuitry 220 to learn what proposals were previously made, and how users had deviated from those prior proposals.

The example return setting proposer circuitry 220 determines whether any additional fields are present for generation of a proposed setting. (Block 670). If additional fields are present the example process of blocks 630 through 670 is repeated until proposed settings have been attempted to be generated for each of the identified fields. Upon determining that no additional fields exist for generation of proposed return settings (e.g., block 670 returns a result of NO), the example return setting proposer circuitry 220 provides the proposed return settings to the example return circuitry 124. (Block 680). The example proposed settings are returned to the return circuitry 124 as a response to the request that initiated the execution of the process 600 of FIG. 6. In some examples, the proposed settings are returned in a JavaScript object notation (JSON) format. However, any other format for providing proposed return settings may additionally or alternatively be used such as, for example, extensible markup language (XML), comma-separated values (CSV), etc. The example process 600 of the illustrated example of FIG. 6 then terminates, but may be re-executed upon subsequent receipt of a request for proposed return settings.

FIG. 7 is a flowchart representative of example machine readable instructions and/or example operations that may be executed, instantiated, and/or performed by example programmable circuitry to implement the return coordinator server 124 of FIG. 1 to interact with a retailer to coordinate return of an item. The example process 700 of the illustrated example of FIG. 7 begins when the example return coordinator server 110 accesses a request to coordinate return of an item. Such a request will be received in response to user reviewing the proposed return settings and indicating their intent to return the item (e.g., by clicking an “initiate return” button). The example return handler circuitry 230 identifies the return settings to be used when coordinating return of the item. (Block 705). In some examples, the request to coordinate return of the item includes the return settings to be used. However, in some other examples, the request may simply include an identifier of the item to be returned, thereby indicating that the return coordinator server 110 is to use the proposed return settings (e.g., the settings proposed in connection with FIG. 6). Additionally or alternatively, the request may include only those fields where the user selected a value different than the proposed return setting.

The example return setting proposer circuitry 220 determines whether any of the return settings included in the request to coordinate return of the item deviate from the proposed settings that were provided in connection with FIG. 6. If any of the return settings deviate from the proposed settings (e.g., block 710 returns a result of YES), the example return setting proposer circuitry 220 stores an identification of the settings that deviated from the proposed settings. (Block 715). Storing such identification enables the return setting proposer circuitry 220 and/or machine learning models, LLMs, neural networks, etc. used by the return setting proposer circuitry 220 to learn from the deviation from the proposed settings. In some examples, additional metadata may be considered when identifying the deviation from the post settings including, for example, an indication by the consumer as to whether the deviation from the proposed setting is temporary (e.g., the consumer may be in a different location than they are normally located). Re-training and/or fine-tuning of the machine learning model(s) may be performed to enable incorporation of the information regarding settings that deviated from their initial proposed value.

The example return handler circuitry 230, using the return settings provided in the request, interacts with a retailer to coordinate the return of the item. (Block 720). To do so, the example return handler circuitry 230 utilizes one or more machine learning models, LLMs, etc. to prepare messages to be used to interact with the retailer on behalf of the consumer. Such interaction may be conducted with the retailer via, for example, a web-based user interface, a chat bot, email messages, text messages, audio messages, etc. In some examples, an operator (e.g., an administrator user of the return coordinator circuitry 110) may control interaction and/or interact with the retailer on behalf of the consumer. Such an approach retains the “one click” interaction with respect to the consumer, even though additional human interaction may be utilized to interact with the retailer.

The example return handler circuitry 230 transmits a notification of the status of the return and/or coordination thereof to the return circuitry 124. (Block 725). Such information enables the return circuitry 124 to provide an indication of the status of the return and/or coordination thereof to the consumer. Such status information may indicate, for example, whether the return is in progress or completed, milestones that have been achieved in coordination of the return, instructions for the consumer (e.g., where to drop off the item in our next steps required by the consumer), etc.

The example return handler circuitry 230 determines whether the return is complete. (Block 730). The return may be considered complete when, for example, a refund has been issued to the consumer. The example return handler circuitry 230 determines whether any additional interaction is needed with the retailer. (Block 735). Additional interaction may be needed, when, for example, the return coordinator server 110 is awaiting a return label to be provided by the retailer and a threshold amount of time has elapsed since the return label was requested. In some examples, the product may be identified as having been delivered to the retailer (e.g., a return location), but a refund might not have yet been issued. In such an example, performing an additional interaction with the retailer might expedite the process of completing the return. However, any other approach to determining whether additional interaction is needed with the retailer may additionally or alternatively be used. If additional interaction is needed (e.g., block 735 returns a result of YES), the example return handler circuitry 230 interacts with the retailer to coordinate the return of the item and/or completion of the return. (Block 720). If no additional interaction is needed with the retailer (e.g., block 735 returns result of NO), the example return handler circuitry 230 provides a notification of the return status to return circuitry 124. (Block 725). In some examples, the notification of the return status may be used to inform the consumer about changes and/or adjustments that have occurred during coordination of the return. For example, the notification may include an indication that a policy of the retailer has recently changed, fees that might be incurred in association with the return, difficulties that might be encountered during transportation, etc. Providing the notification to the return circuitry 124 enables updates to the status of the coordination of the return to be provided in a timely manner. Additionally or alternatively, such notification information concerning the status of the return and/or coordination thereof may be requested by the return circuitry 124, and may be responded to, at any given time.

Returning to block 730, if the example return handler circuitry 230 determines that the return is complete (e.g., block 730 returns a result of YES), the example process 700 of the illustrated example of FIG. 7 terminates. However, the process of FIG. 7 may be re-executed upon, for example, receipt of a request to coordinate return of subsequent item.

FIG. 8 is an example user interface that may be displayed at the direction of the return circuitry of FIG. 1 to display items that may be returned. In some examples, the user interface of the illustrated example of FIG. 8 may be referred to as a home screen. On this home screen, users can see their purchases all in one place. That is, purchases from multiple different retailers may be displayed in one common location. For example, in the illustrated example of FIG. 8, a first item (e.g. a shirt) that had been purchased from an online retailer is displayed along with a second item (e.g., a basketball) that had been purchased from a sporting goods store (e.g., a retailer that is different from the online retailer associated with the first item). Within the home screen, users are able to scroll through all of their purchases in one location. Advantageously, users are enabled to sort and/or search within the user interface to find items that are eligible for return.

In some examples, notifications may be displayed to the user indicating actions that are to be performed by the consumer to for example, complete or return. In some examples, notifications may additionally be provided as push notifications to the user device 122.

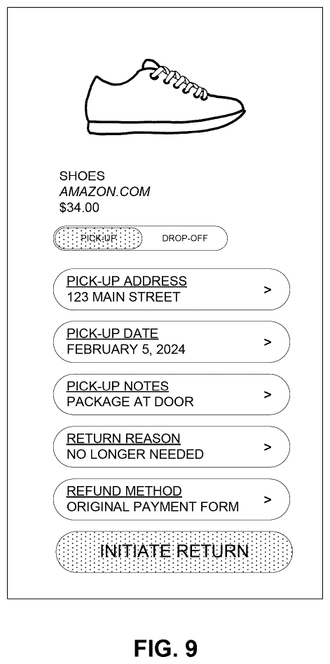

In the illustrated example of FIG. 8, items that are eligible for return are displayed in a tiled format (e.g., a two-column format). However, any other approach to displaying items that are eligible for return may additionally or alternatively be used. The illustrated example of FIG. 8, monetary values of the items to be returned are shown in each of the tiles. In some alternative examples, information concerning a remaining amount of time for returning an item may additionally or alternatively be displayed. For example, a date by which the consumer must indicate their intent to return an item to a given retailer based on, for example policies of that particular retailer may be displayed. Alternatively, a number of days remaining may be displayed. In response to selection of a return button associated with an item, the user is navigated to a second user interface described below in connection with FIG. 9.

FIG. 9 is an example user interface that may be displayed at the direction of the return circuitry 124 of FIG. 1 to display proposed settings for return of an item. In the illustrated example of FIG. 9, an image of the item to be returned, an identification of the retailer to which the item is to be returned, and name of the item, a monetary value of the item, proposed return settings, and an “initiate return” button are displayed. However, any other information relevant to the item and for the coordination of the return thereof may additionally or alternatively be displayed. In the illustrated example of FIG. 9, fields for a pickup address, a pickup date, pickup notes, a return reason, and a desired refund method are displayed. Display of such proposed return settings enables the consumer to review the proposed return settings and make modifications, if necessary and/or desired. In some examples, if a user modifies a proposed return setting, a dialogue may be presented to the user that requests additional information about why the consumer is modifying the proposed setting (e.g., is this a one-time change or should this change be considered permanent and/or applicable to other returns?) Such additional information may then be relayed to the return coordinator server 110 to enable the return setting proposer circuitry 220 to account for such change in future return setting proposal.

FIG. 10 is a block diagram of an example programmable circuitry platform 1000 structured to execute and/or instantiate the example machine-readable instructions and/or the example operations of FIGS. 4, 6, and/or 7 to implement the return coordinator server 110 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example product information retriever circuitry 210, the example return setting proposer circuitry 220, and the example return handler circuitry 230.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 4, 6, and/or 7, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example programmable circuitry platform 1100 structured to execute and/or instantiate the example machine-readable instructions and/or the example operations of FIG. 5 to implement the return circuitry 124 of FIG. 3. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example product information requestor circuitry 310, the example return form display circuitry 320, the example return requestor circuitry 330, and the example return status display circuitry 340.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIG. 5, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1012 of FIG. 10 or the programmable circuitry 1112 of FIG. 11. In this example, the programmable circuitry of FIG. 10 or 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 4, 5, 6, and/or 7 to effectively instantiate the circuitry of FIGS. 1, 2, and/or 3 as logic circuits to perform operations corresponding to those machine readable instructions. In some such examples, the circuitry of FIG. 2 or 3 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 4, 5, 6, and/or 7.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1014, 1016 of FIG. 10, the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above.

For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1012 of FIG. 10, or the programmable circuitry 1112 of FIG. 11. In this example, the programmable circuitry 1012 or the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 4, 5, 6, and/or 7 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4, 5, 6, and/or 7. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 5, 6, and/or 7. As such, the FPGA circuitry 1300 may be configured and/or structured to effectively instantiate some or all of the operations/functions corresponding to the machine readable instructions of the flowchart(s) of FIGS. 4, 5, 6, and/or 7 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 4, 5, 6, and/or 7 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 4, 5, 6, and/or 7 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1012 of FIG. 10, many other approaches are contemplated. For example, FPGA circuitry may include an on-board CPU, such as one or more of the example CPU 1320 of FIG. 12. Therefore, the programmable circuitry 1012 of FIG. 10 and/or the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 4, 5, 6, and/or 7 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 4, 5, 6, and/or 7, and/or an ASIC may be configured and/or structured to perform third operation(s)/function(s) corresponding to a third portion of the machine readable instructions represented by the flowcharts of FIGS. 4, 5, 6, and/or 7.

It should be understood that some or all of the circuitry of FIGS. 2 and/or 3 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIGS. 2 and/or 3 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIGS. 2 and/or 3 may be implemented within one or more virtual machines and/or containers executing on the microprocessor 1200 of FIG. 12.

In some examples, the programmable circuitry 1012 of FIG. 10 and/or the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1012 of FIG. 10 or the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

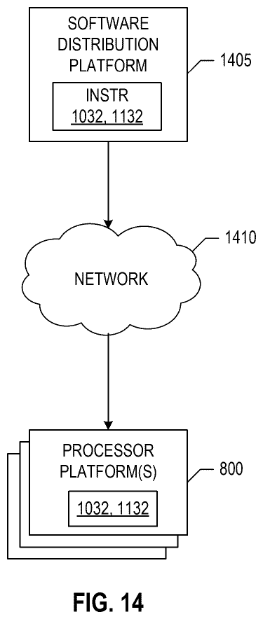

A block diagram illustrating an example software distribution platform 1405 to distribute software such as the example machine readable instructions 1032 of FIG. 10 or the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1032 of FIG. 10 or the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1032 or the example machine readable instructions 1132, which may correspond to the example machine readable instructions of FIGS. 4, 5, 6, and/or 7, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 of the example machine readable instructions 1132 from the software distribution platform 1405. For example, the software, which may correspond to the example machine readable instructions of FIGS. 4, 5, 6, and/or 7, may be downloaded to the example programmable circuitry platform 1000 or the example programmable circuitry platform 1100, which is to execute the machine readable instructions 1032, 1132 to implement the return coordinator server 110 or the return circuitry 124. In some examples, one or more servers of the software distribution platform 1405 periodically offer, transmit, and/or force updates to the software (e.g., the example machine readable instructions 1032 of FIG. 10, the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable efficient initiation of coordination of a return of a product. Disclosed systems, apparatus, articles of manufacture, and methods improve the efficiency of using a computing device by generating proposed return settings to be presented to a user, thereby reducing the amount of time a user must spend filling in each field individually. Disclosed systems, apparatus, articles of manufacture, and methods are accordingly directed to one or more improvement(s) in the operation of a machine such as a computer or other electronic and/or mechanical device.

As noted above, U.S. Provisional Patent Application No. 63/495,963, which was filed on Apr. 13, 2023, is hereby incorporated by reference in its entirety.

From the foregoing, it will be appreciated that example systems, apparatus, articles of manufacture, and methods have been disclosed that enable pick-up of packages using identifiers that are not related to shipment purposes. Such approaches reduce the amount of time taken to correctly identify a package by a courier, and also reduce the likelihood that an incorrect package is obtained.

Example 1 includes at least one non-transitory machine-readable medium comprising machine-readable instructions that, when executed, cause at least one processor circuit to at least: aggregate order information from at least one retailer; provide the aggregated order information to a consumer device, the aggregated order information representing one or more products that are available for return; in response to selection of a product to be returned, identify a proposed value for return of the product based on at least one of product information, transportation information, retailer information, or consumer information; provide the proposed value to the consumer device, the proposed value to be used as a default value for a return field, a selected value of the return field to be used in coordination of return of the product; access a return instruction from the consumer device, the return instruction identifying the product to be returned and the selected value; and after access of the return instruction, communicate with a retailer associated with the product to coordinate return of the product based on the selected value.

Example 2 includes the at least one non-transitory machine-readable medium of example 1, wherein, to identify the proposed value, the instructions are to cause one or more of the at least one processor circuit to: generate a first potential value of the proposed value for the return field based on at least one of the product information, transportation information, retailer information, or consumer information; generate a first confidence score for the first potential value, the first confidence score representing a predicted likelihood a consumer associated with the consumer device will agree to the first potential value; and determine that the first confidence score meets a threshold, wherein the providing of the proposed value to the consumer device includes providing the first potential value based on the determination that the first confidence score meets the threshold.

Example 3 includes the at least one non-transitory machine-readable medium of example 1 or example 2, wherein the instructions are to cause one or more of the at least one processor circuit to: identify a second return field; generate a second potential value for the second return field; generate a second confidence score for the second potential value; determine the second confidence score does not meet the threshold; and provide an empty value in connection with the second return field to the consumer device.

Example 4 includes the at least one non-transitory machine-readable medium of any one of examples 1-3, wherein the instructions are to cause one or more of the at least one processor circuit to provide the proposed value to the consumer device for output via a user interface, the user interface to present the proposed value in the return field to be used to direct the return of the product.

Example 5 includes the at least one non-transitory machine-readable medium of any one of examples 1-4, wherein the user interface is to enable a user of the consumer device to initiate the return of the product according to the proposed value with one press of a button.

Example 6 includes the at least one non-transitory machine-readable medium of any one of examples 1-5, wherein the return field represents at least one of a reason for the return, whether a consumer associated with the consumer device will drop off the product or have the product picked up, a drop-off or pick-up location, a date and time for pick-up or drop off, a desired refund method, and information related to an exchange of the product.

Example 7 includes the at least one non-transitory machine-readable medium of any one of examples 1-6, wherein the instructions are to cause one or more of the at least one processor circuit to execute a machine learning model to identify the proposed value.

Example 8 includes the at least one non-transitory machine-readable medium of any one of examples 1-7, wherein the instructions are to cause one or more of the at least one processor circuit to: determine that the selected value is different than the proposed value; and store the selected value.

Example 9 includes the at least one non-transitory machine-readable medium of any one of examples 1-8, wherein the product is a first product from a first retailer and the proposed value is a first proposed value, a second product from a second retailer is selected for return, and wherein the instructions are to cause one or more of the at least one processor circuit to at least identify a second proposed value for the return of the second product.

Example 10 includes the at least one non-transitory machine-readable medium of any one of examples 1-9, wherein the wherein the retailer information includes at least one of retailer drop-off location preferences, retailer shipping service provider preferences, past retailer return preferences, retailer return policies, retailer timing preferences, and an address of the retailer.

Example 11 includes the at least one non-transitory machine-readable medium of one any of examples 1-10, wherein the consumer information includes at least one of consumer drop-off location preferences, pick-up timing preferences, refund preferences, a current location of a consumer associated with the consumer device, a typical location of the consumer, past consumer return preferences, and consumer timing preferences.

Example 12 includes the at least one non-transitory machine-readable medium of one any of examples 1-11, wherein the transportation information includes at least one of carrier availability, a carrier location, carrier costs, packaging requirements, drop-off availability, pickup availability, and route optimization.

Example 13 includes the at least one non-transitory machine-readable medium of any one of examples 1-12, wherein the product information includes at least one of a type of the product, a size of the product, a weight of the product, a date of purchase, a date of delivery, transportation constraints associated with the product, and return policies associated with the product.

Example 14 includes an apparatus including: interface circuitry; machine-readable instructions; and at least one processor circuit to be programmed by the machine-readable instructions to: aggregate order information from at least one retailer; provide the aggregated order information to a consumer device, the aggregated order information corresponding to one or more products that are available for return; identify a default value for return of a product of the one or more products based on at least one of product information, transportation information, retailer information, or consumer information; provide the default value to the consumer device in a return field, a selected value of the return field to be used in coordination of return of the product; access a return instruction from the consumer device, the return instruction identifying the product to be returned and the selected value; and after access of the return instruction, communicate with a retailer associated with the product to coordinate return of the product based on the selected value.

Example 15 includes the apparatus of example 14, wherein, to identify the default value, one or more of the at least one processor circuit is to: generate a first potential value of the default value for the return field based on at least one of the product information, transportation information, retailer information, or consumer information; generate a first confidence score for the first potential value, the first confidence score representing a predicted likelihood a consumer associated with the consumer device will agree to the first potential value; and determine that the first confidence score meets a threshold, wherein the providing of the default value to the consumer device includes providing the first potential value based on the determination that the first confidence score meets the threshold.

Example 16 includes the apparatus of example 14 or example 15, wherein one or more of the at least one processor circuit is to: identify a second return field; generate a second potential value for the second return field; generate a second confidence score for the second potential value; determine the second confidence score does not meet the threshold; and provide an empty value in connection with the second return field to the consumer device.

Example 17 includes the apparatus of any one of examples 14-16, wherein one or more of the at least one processor circuit is to provide the default value to the consumer device for output via a user interface, the user interface to present the default value in the return field to be used to direct the return of the product.

Example 18 includes the apparatus of any one of examples 14-17, wherein one or more of the at least one processor circuit is to enable a user of the consumer device to initiate the return of the product according to the default value with one press of a button.

Example 19 includes the apparatus of any one of examples 14-18, wherein the return field represents at least one of a reason for the return, whether a consumer associated with the consumer device will drop off the product or have the product picked up, a drop-off or pick-up location, a date and time for pick-up or drop off, a desired refund method, and information related to an exchange of the product.

Example 20 includes the apparatus of any one of examples 14-19, wherein one or more of the at least one processor circuit is to execute a machine learning model to identify the default value.

Example 21 includes the apparatus of any one of examples 14-20, wherein one or more of the at least one processor circuit is to: determine that the selected value is different than the default value; and store the selected value.

Example 22 includes the apparatus of any one of examples 14-21, wherein the product is a first product from a first retailer and the default value is a first default value, a second product from a second retailer is selected for return, and wherein one or more of the at least one processor circuit is to at least identify a second default value for the return of the second product.

Example 23 includes the apparatus of any one of examples 14-22, wherein the wherein the retailer information includes at least one of retailer drop-off location preferences, retailer shipping service provider preferences, past retailer return preferences, retailer return policies, retailer timing preferences, and an address of the retailer.

Example 24 includes the apparatus of any one of examples 14-23, wherein the consumer information includes at least one of consumer drop-off location preferences, pick-up timing preferences, refund preferences, a current location of a consumer associated with the consumer device, a typical location of the consumer, past consumer return preferences, and consumer timing preferences.

Example 25 includes the apparatus of any one of examples 14-24, wherein the transportation information includes at least one of carrier availability, a carrier location, carrier costs, packaging requirements, drop-off availability, pickup availability, and route optimization.

Example 26 includes the apparatus of any one of examples 14-25, wherein the product information includes at least one of a type of the product, a size of the product, a weight of the product, a date of purchase, a date of delivery, transportation constraints associated with the product, and return policies associated with the product.

Example 27 includes a method including: aggregating order information from at least one retailer; providing the aggregated order information to a consumer device, the aggregated order information representing one or more products that are available for return; in response to selection of a product to be returned, identifying, by at least one processor circuit programmed by at least one instruction, a proposed value for return of the product based on at least one of product information, transportation information, retailer information, or consumer information; providing the proposed value to the consumer device, the proposed value to be used as a default value for a return field, a selected value of the return field to be used in coordination of return of the product; accessing a return instruction from the consumer device, the return instruction identifying the product to be returned and the selected value; and after accessing the return instruction, communicating with a retailer associated with the product to coordinate return of the product based on the selected value.

Example 28 includes the method of example 27, wherein identifying the proposed value includes: generating a first potential value of the proposed value for the return field based on at least one of the product information, transportation information, retailer information, or consumer information; generating a first confidence score for the first potential value, the first confidence score representing a predicted likelihood a consumer associated with the consumer device will agree to the first potential value; and determining that the first confidence score meets a threshold, wherein the providing of the proposed value to the consumer device includes providing the first potential value based on the determination that the first confidence score meets the threshold.

Example 29 includes the method of example 27 or example 28, further including: identifying a second return field; generating a second potential value for the second return field; generating a second confidence score for the second potential value; determining the second confidence score does not meet the threshold; and providing an empty value in connection with the second return field to the consumer device.

Example 30 includes the method of any one of examples 27-29, further including providing the proposed value to the consumer device for output via a user interface, the user interface to present the proposed value in the return field to be used to direct the return of the product.

Example 31 includes the method of any one of examples 27-30, wherein the user interface is to enable a user of the consumer device to initiate the return of the product according to the proposed value with one press of a button.

Example 32 includes the method of any one of examples 27-31, wherein the return field represents at least one of a reason for the return, whether a consumer associated with the consumer device will drop off the product or have the product picked up, a drop-off or pick-up location, a date and time for pick-up or drop off, a desired refund method, and information related to an exchange of the product.

Example 33 includes the method of any one of examples 27-32, wherein identifying the proposed value includes executing a machine learning model.

Example 34 includes the method of any one of examples 27-33, further including: determining that the selected value is different than the proposed value; and storing the selected value.

Example 35 includes the method of any one of examples 27-34, wherein the product is a first product from a first retailer and the proposed value is a first proposed value, a second product from a second retailer is selected for return, the method further including identifying a second proposed value for the return of the second product.

Example 36 includes the method of any one of examples 27-35, wherein the retailer information includes at least one of retailer drop-off location preferences, retailer shipping service provider preferences, past retailer return preferences, retailer return policies, retailer timing preferences, and an address of the retailer.

Example 37 includes the method of any one of examples 27-36, wherein the consumer information includes at least one of consumer drop-off location preferences, pick-up timing preferences, refund preferences, a current location of a consumer associated with the consumer device, a typical location of the consumer, past consumer return preferences, and consumer timing preferences.

Example 38 includes the method of any one of examples 27-37, wherein the transportation information includes at least one of carrier availability, a carrier location, carrier costs, packaging requirements, drop-off availability, pickup availability, and route optimization.

Example 39 includes the method of any one of examples 27-38, wherein the product information includes at least one of a type of the product, a size of the product, a weight of the product, a date of purchase, a date of delivery, transportation constraints associated with the product, and return policies associated with the product.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions that, when executed, cause at least one processor circuit to at least:
aggregate order information from at least one retailer;
provide the aggregated order information to a consumer device, the aggregated order information representing one or more products that are available for return;
in response to selection of a product to be returned, identify a proposed value for return of the product based on at least one of product information, transportation information, retailer information, or consumer information;
provide the proposed value to the consumer device, the proposed value to be used as a default value for a return field, a selected value of the return field to be used in coordination of return of the product;
access a return instruction from the consumer device, the return instruction identifying the product to be returned and the selected value; and
after access of the return instruction, communicate with a retailer associated with the product to coordinate return of the product based on the selected value.

2. The at least one non-transitory machine-readable medium of claim 1, wherein, to identify the proposed value, the instructions are to cause one or more of the at least one processor circuit to:
generate a first potential value of the proposed value for the return field based on at least one of the product information, transportation information, retailer information, or consumer information;
generate a first confidence score for the first potential value, the first confidence score representing a predicted likelihood a consumer associated with the consumer device will agree to the first potential value; and
determine that the first confidence score meets a threshold, wherein the providing of the proposed value to the consumer device includes providing the first potential value based on the determination that the first confidence score meets the threshold.

3. The at least one non-transitory machine-readable medium of claim 2, wherein the instructions are to cause one or more of the at least one processor circuit to:
identify a second return field;
generate a second potential value for the second return field;
generate a second confidence score for the second potential value;
determine the second confidence score does not meet the threshold; and
provide an empty value in connection with the second return field to the consumer device.

4. The at least one non-transitory machine-readable medium of claim 1, wherein the instructions are to cause one or more of the at least one processor circuit to provide the proposed value to the consumer device for output via a user interface, the user interface to present the proposed value in the return field to be used to direct the return of the product.

5. The at least one non-transitory machine-readable medium of claim 4, wherein the user interface is to enable a user of the consumer device to initiate the return of the product according to the proposed value with one press of a button.

6. The at least one non-transitory machine-readable medium of claim 4, wherein the return field represents at least one of a reason for the return, whether a consumer associated with the consumer device will drop off the product or have the product picked up, a drop-off or pick-up location, a date and time for pick-up or drop off, a desired refund method, and information related to an exchange of the product.

7. The at least one non-transitory machine-readable medium of claim 1, wherein the wherein the retailer information includes at least one of retailer drop-off location preferences, retailer shipping service provider preferences, past retailer return preferences, retailer return policies, retailer timing preferences, and an address of the retailer.

8. The at least one non-transitory machine-readable medium of claim 1, wherein the consumer information includes at least one of consumer drop-off location preferences, pick-up timing preferences, refund preferences, a current location of a consumer associated with the consumer device, a typical location of the consumer, past consumer return preferences, and consumer timing preferences.

9. The at least one non-transitory machine-readable medium of claim 1, wherein the transportation information includes at least one of carrier availability, a carrier location, carrier costs, packaging requirements, drop-off availability, pickup availability, and route optimization.

10. The at least one non-transitory machine-readable medium of claim 1, wherein the product information includes at least one of a type of the product, a size of the product, a weight of the product, a date of purchase, a date of delivery, transportation constraints associated with the product, and return policies associated with the product.

11. An apparatus comprising:
interface circuitry;
machine-readable instructions; and
at least one processor circuit to be programmed by the machine-readable instructions to:
aggregate order information from at least one retailer;
provide the aggregated order information to a consumer device, the aggregated order information corresponding to one or more products that are available for return;
identify a default value for return of a product of the one or more products based on at least one of product information, transportation information, retailer information, or consumer information;
provide the default value to the consumer device in a return field, a selected value of the return field to be used in coordination of return of the product;
access a return instruction from the consumer device, the return instruction identifying the product to be returned and the selected value; and
after access of the return instruction, communicate with a retailer associated with the product to coordinate return of the product based on the selected value.

12. The apparatus of claim 11, wherein, to identify the default value, one or more of the at least one processor circuit is to:
generate a first potential value of the default value for the return field based on at least one of the product information, transportation information, retailer information, or consumer information;
generate a first confidence score for the first potential value, the first confidence score representing a predicted likelihood a consumer associated with the consumer device will agree to the first potential value; and
determine that the first confidence score meets a threshold, wherein the providing of the default value to the consumer device includes providing the first potential value based on the determination that the first confidence score meets the threshold.

13. The apparatus of claim 12, wherein one or more of the at least one processor circuit is to:
identify a second return field;
generate a second potential value for the second return field;
generate a second confidence score for the second potential value;
determine the second confidence score does not meet the threshold; and
provide an empty value in connection with the second return field to the consumer device.

14. The apparatus of claim 11, wherein one or more of the at least one processor circuit is to execute a machine learning model to identify the default value.

15. The apparatus of claim 11, wherein one or more of the at least one processor circuit is to:
determine that the selected value is different than the default value; and
store the selected value.

16. A method comprising:
aggregating order information from at least one retailer;
providing the aggregated order information to a consumer device, the aggregated order information representing one or more products that are available for return;
in response to selection of a product to be returned, identifying, by at least one processor circuit programmed by at least one instruction, a proposed value for return of the product based on at least one of product information, transportation information, retailer information, or consumer information;
providing the proposed value to the consumer device, the proposed value to be used as a default value for a return field, a selected value of the return field to be used in coordination of return of the product;
accessing a return instruction from the consumer device, the return instruction identifying the product to be returned and the selected value; and
after accessing the return instruction, communicating with a retailer associated with the product to coordinate return of the product based on the selected value.

17. The method of claim 16, further including providing the proposed value to the consumer device for output via a user interface, the user interface to present the proposed value in the return field to be used to direct the return of the product.

18. The method of claim 17, wherein the user interface is to enable a user of the consumer device to initiate the return of the product according to the proposed value with one press of a button.

19. The method of claim 17, wherein the return field represents at least one of a reason for the return, whether a consumer associated with the consumer device will drop off the product or have the product picked up, a drop-off or pick-up location, a date and time for pick-up or drop off, a desired refund method, and information related to an exchange of the product.

20. The method of claim 16, wherein the product is a first product from a first retailer and the proposed value is a first proposed value, a second product from a second retailer is selected for return, the method further including identifying a second proposed value for the return of the second product.
